(19) United States
(12) Patent Application Publication
(10) Pub. No.: US 2004/0095400 A1
(43) Pub. Date: May 20, 2004

(54) Reconfiguration of content for display on devices of different types

(76) Inventors: Andrew T. Anderson, Los Gatos, CA (US); Charles Y. Chen, San Francisco, CA (US)

Correspondence Address: SKJERVEN MORRILL LLP, THREE EMBARCADERO CENTER, 28TH FLOOR, SAN FRANCISCO, CA, 94111, US

(21) Appl. No.: 10/300,425

(22) Filed: Nov. 19, 2002

(51) Int. Cl. G09G 5/00

(52) U.S. Cl. 345/864

(57) ABSTRACT

A system and method are disclosed for automatic manipulation of content for display on different devices, including devices having small display areas. In one embodiment, the disclosed system and method provide for reconfiguration of source content by manipulating the source content from top to bottom and from right to left. Elements of the source content that are not commonly supported among a wide array of devices and formats, as well as spacer images, are filtered from the source content. Table data is reconfigured by copying the table content and replacing the table cells with line breaks. Further, if the source content is larger than a predetermined size, a reconfiguration application divides the source content into sub-documents, each sub-document having a size smaller or equal to the threshold size. Individual sub-documents may include a link to another one of the sub-documents. By reconfiguring the source content, the source content may be transmitted to and displayed at any of a wide variety of devices.

### CROSS REFERENCE TO ATTACHED APPENDICES

Appendix A is a Compact Disk, of which two identical copies are attached hereto, and forms a part of the present disclosure. Appendix B to this application lists the filenames, creation dates, and sizes (in bytes) of the files stored on the compact disks of Appendix A, each of which is hereby incorporated by this reference in its entirety.

### RESERVATION OF COPYRIGHT

A claim of copyright protection is made on portions of the description in this patent document, including the contents of the Compact Disk Appendix. The copyright owner has no objection to the facsimile reproduction of the patent document or the patent disclosure, exactly as it appears in the Patent and Trademark Office patent file or records, but reserves all other rights whatsoever.

### TECHNICAL FIELD

The present system and method generally relate to the reconfiguration of source content for display on devices of different type. More specifically, the present system and method relate to the reconfiguration of content designed for display on one set of display devices for display at any of a wide variety of devices of different types.

### BACKGROUND

Wireless Internet access is growing as an increasing number of users gain wireless Internet access. Wireless access is typically obtained through the end users' handheld or mobile devices such as cellular telephones, personal digital assistants (PDAs), pagers, laptop computers, handheld personal computers (PCs), and various other devices.

Such devices typically have smaller display areas when compared to those of traditional desktop personal computer screen displays. Typical web protocols and data formats such as HTML (HyperText Markup Language) are, however, better suited for devices or systems such as desktop personal computers with relatively large amounts of RAM (Random Access Memory). WAP and other emerging standards like BREW, J2ME, Bluetooth, and the like, provide an environment for wireless applications.

WAP and these other emerging standards feature device-specific languages, such as WML and xHTML-mp. For example, WAP (Wireless Application Protocol) is a standard that provides cellular telephones, pagers, and various other handheld devices with access to electronic mail as well as text-based web pages. WAP provides a complete environment for wireless applications that includes a wireless counterpart of TCP/IP. WAP features the Wireless Markup Language (WML), a streamlined version of HTML for small screen displays that was derived from HDML (Handheld Device Markup Language). HDML is a specialized version of HTML designed to enable handheld devices to obtain information from web pages, developed prior to the standardization of the WAP specification. WAP can operate independent of the air interface, e.g., GSM (Global System for Mobile Communications), TDMA (Time Division Multiple Access), CDMA (Code Division Multiple Access), CDPD (Cellular Digital Packet Data), MEN (Integrated Digital Enhanced Network), PDC (Personal Digital Communications), etc., and independent of the device on which it operates.

WAP operates with the use of a WAP Gateway/Application Server. The WAP Gateway interfaces between the web server and a microbrowser in the mobile device by encoding and decoding WAP pages between the web server and the microbrowser.

With the web pages layout being designed for the conventional, larger desktop display, many of the web pages currently available over the Internet are not configured for optimal display and viewing on devices with small display areas. For example, a web page may contain information or display on the left, right, top and/or bottom borders of the web page, such as with the use of frames, in addition to the key information contained in a main or central portion of the particular web page. Because the conventional desktop display is sufficiently large, all or most of the borders and the centrally located main content can be viewed in a single web browser window without the need for the user to scroll down or to the right.

With conventional solutions that attempt to provide a web-like experience to the end user via a handheld device, an initial viewable portion displayed on the smaller display area of the handheld device may only contain a top left portion such as the main table of contents of a conventional web page designed for desktop display and viewing. Even when the user clicks a link to access a different web page, the portion of the display that is viewable in the display area may still contain the same specific portion such as the main table of contents of the conventional web page. The end user must scroll down and/or to the right in order to view the portion of the display content that is different from the previous page. Most cellular telephone browsers cannot scroll to the right or left, thus, even with the above-described mobile or small display solutions, the end user is unable to have a web-like experience using a mobile computing device. Additional background details are disclosed in U.S. patent application Ser. No. 09/626,835, the disclosure of which is incorporated herein by reference.

### SUMMARY

Accordingly, a need exists for a system and method for analyzing, transforming, and reconfiguring web content for display such as on devices with small display areas. The system and method may additionally transmit and deliver such reconfigured content to the device. It is also desirable to provide such reconfiguration of the content in a quick and efficient manner with mobile device-specific content aggregated therein. In one embodiment, the system and method provide a user experience similar to that experienced by users of large display screen devices, such as desktop personal computers.

Embodiments of a system and method for manipulating content such as a website by analyzing, extracting, re-scaling, and/or reconfiguring for display on devices such as those with small display areas are disclosed. Although such system and method are well-utilized in devices with small display areas, it is to be understood that such system and method may be implemented in any suitable device and/or display configuration. For example, the system and method may be utilized in a conventional desktop personal computer display when multiple web pages are simultaneously displayed, such as in multiple browser windows. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines.

In general, a reconfiguration application automatically converts source content, such as an HTML web page, into a base format that is supported by a wide variety of devices. In converting the source content into the base format, the reconfiguration application removes or modifies elements of the source content that are not commonly supported by a wide variety of devices. The reconfiguration application may be employed to convert the format of a wide variety of source documents from a variety of different sources.

Pursuant to one embodiment, a reconfiguration application is provided for reconfiguring source content for display on a client display. Initially, the reconfiguration application receives source content from a source and filters a set of predetermined elements that are not commonly supported by devices having small displays. Next, the reconfiguration application identifies table content within the source content, the table content having a plurality of table cells arranged in columns and rows. The reconfiguration application then copies the content from individual table cells and separates the table content from the individual table cells using line break elements.

In accordance with other aspects of the present invention, the reconfiguration application removes HTML tags from within the source content. Removal of tags of the source content permits the modified content to be displayed at devices that do not support tags.

Further, features, such as background color, DIV elements, and spacer images may be removed by the reconfiguration application in modifying the source content. Removal of these features permits the modified content to be displayed at devices that do not support the same.

Because many client devices, such as many devices having small display areas, do not support frames, the reconfiguration application reconfigures source content that includes frames. In one embodiment, the reconfiguration application creates a link associated with each frame within the source content and lists these created links in an output file. Users at client devices can then access the associated frames by activating the associated created links.

Further, many devices do not support scripts, objects, or the like. Accordingly, the reconfiguration application analyzes the source content and determines the presence of scripts or objects and removes these aspects of the source content to permit the modified content to be supportable on a wide variety of client devices.

Many devices, handheld wireless devices in particular, have small display areas and small amounts of available memory for storing content received from the reconfiguration application. Accordingly, in some embodiments, the reconfiguration application evaluates the size of the modified content and, if the modified content exceeds a predetermined size, the reconfiguration application divides the modified content into a plurality of sub-documents. The reconfiguration application also includes a link in each of the sub-documents to a subsequent sub-document, if any. The predetermined size may be selected or calculated based on the size of the memory of the receiving client device.

A computer program product that reconfigures a source content for display on a client display is also disclosed. The computer program product generally comprises computer code that receives a source content from a source, computer code that reconfigures the source content to a reconfigured content for display, computer code that transmits the reconfigured content to the client display for display on the client display, and a computer readable medium that stores the computer codes.

These and other features and advantages of the present invention will be presented in more detail in the following detailed description and the accompanying figures that illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a block diagram illustrating an overview of the communications among a source document or web content, a device such as a handheld device, and a system for analyzing, transforming, and reconfiguring web content for display such as on devices with small display areas;

FIG. 2 is a block diagram illustrating exemplary components of a web page configured for display on a typical personal computer display;

FIG. 3 is a flow chart illustrating a communication process between the client small display device and the reconfiguration application;

FIG. 4 is a flow chart illustrating a process for analyzing, transforming, and configuring web content for display on devices with small display areas;

FIG. 5 is a flowchart illustrating a reconfiguration process for reconfiguring content for different display devices in accordance with an embodiment of the invention.

### DETAILED DESCRIPTION

A system and method for the manipulation of content such as a website by analyzing, extracting, re-scaling, and/or reconfiguring the content for display such as on devices with small display areas are disclosed. The following description is presented to enable persons skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

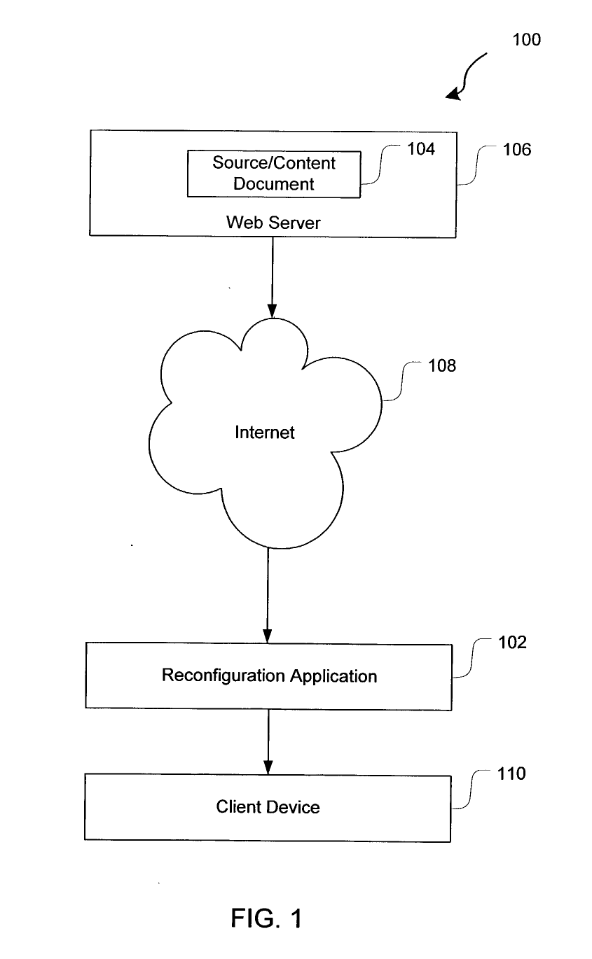

FIG. 1 illustrates a system 100 and communications compatible with WAP or xHTML-mp among the components of the system 100. These components include a source document or web content 104, a client device 110, and a system or application 102 for analyzing, transforming, and reconfiguring or otherwise manipulating web content for display on devices such as devices with small display areas via a network, such as the Internet 108.

The client device 110 may comprise any of a wide variety of client devices, including, but not limited to cellular telephones, personal digital assistants (PDAs), desktop personal computers, laptop computers, or any other suitable client device 110 configured to receive data from over a network.

As shown, the source document 104 typically resides on or is stored at a web server 106. Although shown as a separate web server component, the web server 106 may be an actual web server, a proxy server, a cache, or any other suitable form for storing the source content document 104 and for allowing access to the stored source content document 104 via the Internet 108. The web server 106 is in communication with the Internet 108 such that client applications such as web browsers on devices such as personal computers or any web-enabled devices may gain access to the source document or content 104 via the Internet 108.

The reconfiguration application 102 generates reconfigured content or document from the source content 104 and is in communication with the web server 106 that contains the web content 104 via the Internet 108. Thus, in one embodiment, the reconfiguration application 102 retrieves the source document 104 from the web server 106 via the Internet 108.

The reconfiguration application 102 is also in communication with the device 110. Although the system and method are described herein as utilized by a client device with small display areas, it is to be understood that the system and method may be implemented in any suitable device and/or display configuration. For example, the system and method may be utilized in a conventional desktop personal computer display when multiple web pages are simultaneously displayed, such as in multiple browser windows.

Although not shown, the reconfiguration application 102 may optionally be in communication with the device 110 via a wireless ISP or any other suitable intermediary entity, for example. In another embodiment, the reconfiguration application 102 communicates with the device 110 via at least a portion of the Internet 108. The reconfiguration application 102 may receive requests and/or any other form of data from the device 110 destined for the web server 106. For example, the device 110 may transmit a URL (Uniform Resource Locator) request to the reconfiguration application 102. The URL request may correspond to the web server or host 106 and the particular web page or source document 104 requested. The reconfiguration application 102 then retrieves the requested document 104 from the web server 106 using the URL specified. As another example, the device 110 may transmit data, such as data appended to the URL for a server-side CGI (Common Gateway Interface) program, or any other suitable forms of data.

The reconfiguration application 102 may also transmit responses to the device 10 for display. For example, in response to a request and/or data received from the device 110, the reconfiguration application 102 may forward the request and/or data to the destination web server 106, receive response from the web server 106 in the form of web content, reconfigure or otherwise manipulate the content, and transmit the reconfigured document to the device 110. It is noted that the reconfiguration application 102 may also reconfigure any request and/or data from the device 10 prior to forwarding the request and/or data to the destination web server 106.

It is to be understood that the reconfiguration application 102 or algorithm for implementing the reconfiguration application 102 may reside in any suitable location or form. For example, the reconfiguration application 102 may reside on a server remote to the device 110. The remote server may be either separate from or collocated with the servers of a wireless ISP. In one example, the reconfiguration application 102 may reside and operate with a proxy server that facilitates communication between the target web server via the Internet and the small display device 100. Alternatively, the reconfiguration application 102 may be implemented by the device 10. For example, the reconfiguration application 102 may be implemented as a separate application, such as a plug-in for an existing browser, that can be executed in conjunction with a browser. As another example, the reconfiguration application 102 may be implemented as an algorithm in a web-intelligent web browser for the device 110.

When a proxy server is utilized, communication from the device 110 is typically redirected to the proxy server rather than the specified target webpage. For example, if the end user specifies a destination URL such as www.yahoo.com, the device 110 does not directly communicate with the host server of the specified destination URL. Rather, communication is between the device 10 and the proxy server at which the reconfiguration application 102 resides, which, in turn, communicates with the specified destination URL.

The reconfiguration application 102, in one embodiment, can be executed independent of the operating systems utilized by the device 110. For example, the reconfiguration application 102 may be executed on a device 10 that utilizes the Palm, WinCE, Symbian, RIM (Research in Motion), or any other suitable operating system. The reconfiguration application 102 is also preferably device-independent such that the reconfiguration application 102 can be utilized regardless of the particular device 110. In addition, the device 110 is optionally compatible with and can handle HTML 3.x.

In addition, the reconfiguration application 102 optionally is independent of the carrier signal of the small display device and independent of the device on which it operates. Examples of types of carrier signals or air interfaces include GSM, TDMA, CDMA, CDPD, iDEN, PDC, Sprint PCS, packet switch, broadband wireless, G3, any wireless or LAN connection, etc. The reconfiguration application 102 is also optionally compatible with WAP.

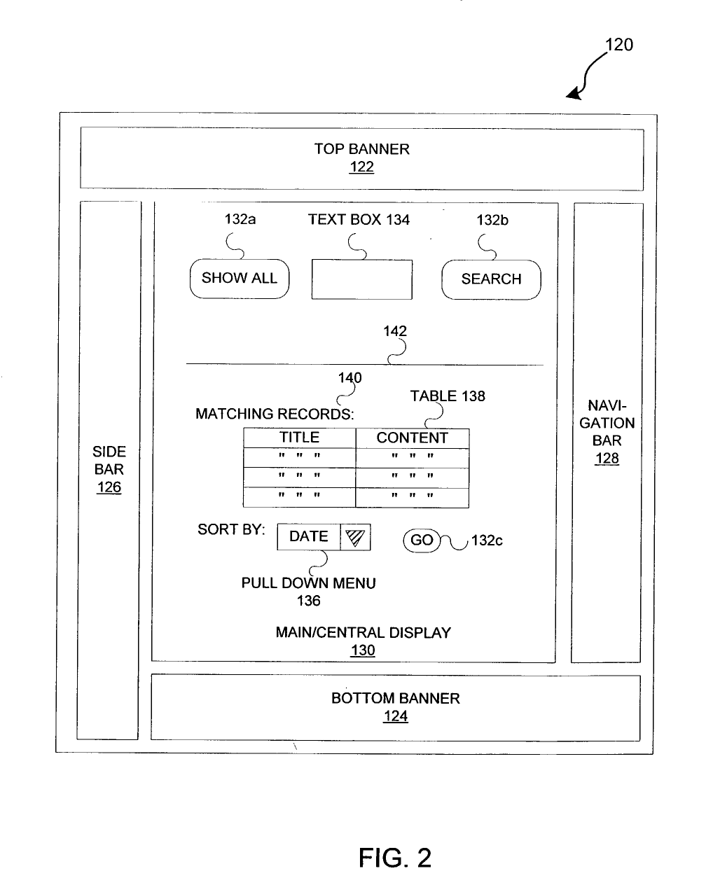

FIG. 2 is a block diagram illustrating exemplary components of a web page 120 configured for display on a typical personal computer display. As shown, the exemplary web page 120 may include border displays such as a top banner 122, a bottom banner 124, a side bar 126, and/or a navigation bar 128, and a main or central display 130. The top banner 122 is typically an advertisement or a main table of contents while the bottom banner 124 typically includes various links to miscellaneous information such as privacy statement, copyright, disclaimer, contact information, and/or a site map for the website.

The side bar may include a main table of contents, if a main table of contents is not included as part of the top banner 122, and/or a more detailed table of contents for the particular portion of the web content currently being displayed in the central display 130 of the web page 120. As is evident, any other combinations of border display, if any, may be implemented.

The main or central display 130 may include any combination of elements such as various submission buttons 132a, 132b, 132c, text box 134, pull down menu 135, table 138, simple text 140 such as headings and/or body text, layout tools such as a horizontal line 142, numbered and/or unnumbered lists, graphics, and/or various other suitable components.

As is evident, there are various types or classes of web pages. In a simple case, the web page or content merely contains a single page of text that is read from top to bottom. In such a case, little, if any, reconfiguration is necessary in order for the small display device to display such a web page.

However, many web pages have more complex layouts, such as the one shown in FIG. 2. For example, a web page may have disjointed content that includes banners, a navigation bar, a table of contents, and/or various other links, in addition to the central portion of the display. Such disjointed content may be implemented as tables, frames with static or relatively static borders, and/or forms. In the case of a table, the given table may be a single-cell table such that the table is simply a method for formatting rather than to gather and display information as may be the case for multi-cell tables. In the case of a form, the form may contain a number of fields. A form is typically utilized by e-commerce websites in which the end user can fill out text boxes such as delivery and billing address, credit card numbers, and/or check or select various selections.

For these more complex web pages, reconfiguration is typically desirable in order for the small display device to display the more complex web pages in an efficient, coherent, and user-friendly manner.

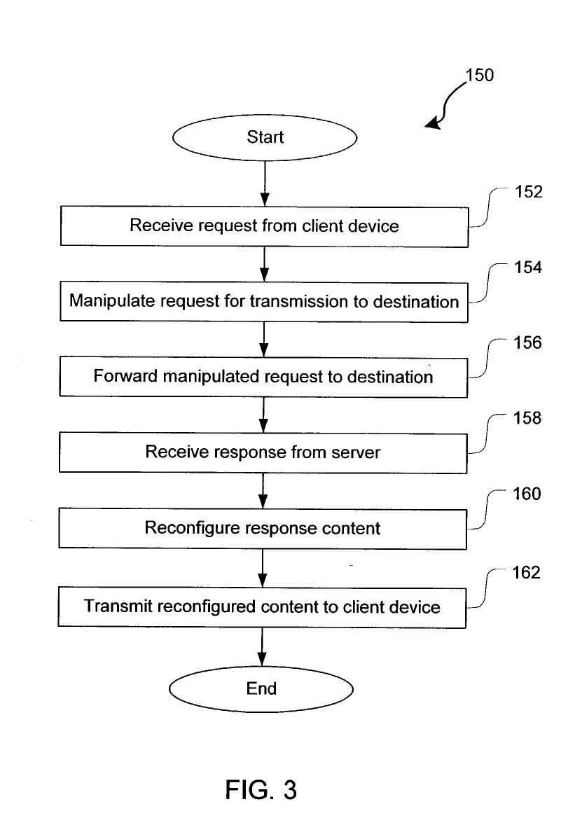

FIG. 3 is a flow chart illustrating a communication process 150 between the client device 110 (FIG. 1) and the reconfiguration application 102 (FIG. 1). At step 152, the reconfiguration application 102 receives a request and/or data from the client device 110. The reconfiguration application 102 reconfigures the request and/or data, if necessary, at step 154 and forwards the reconfigured request and/or data to the destination host server via the Internet, at step 156. For example, if the reconfiguration application 102 resides at a proxy server, the reconfiguration application 102 may reconfigure the URL and/or other information transmitted by the device 110 and generate a packet identifying the proxy server rather than the device 110 as the source.

At step 158, the reconfiguration application 102 (FIG. 1) receives a response from the destination host server. The response is typically in a format or in accordance with a protocol that is suitable for the conventional large display. At step 160, the reconfiguration application analyzes, transforms, reconfigures, and/or otherwise manipulates the source/content document of the response for display on devices particularly those with small display areas such as WAP or xHTML-mp. Lastly, at step 162, the reconfigured page is transmitted to the device 110 for display.

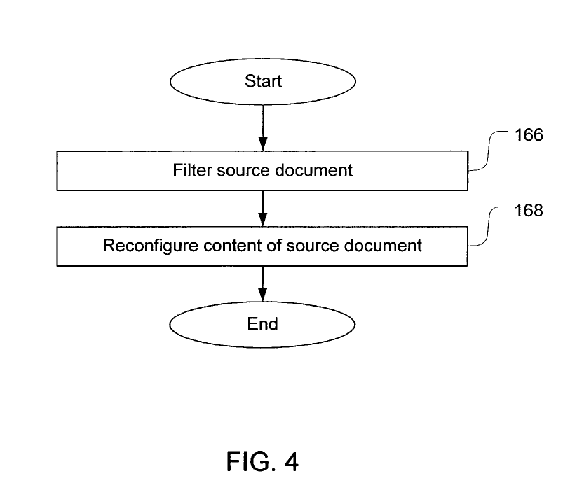

FIG. 4 is a flow chart illustrating the process 160 executed by the manipulation or reconfiguration application for analyzing, transforming, reconfiguring, and/or otherwise manipulating web content for display on devices with small display areas. At step 166, the reconfiguration application filters the source document for various components such as advertisements, banner across a top border, banner across a bottom border, table of contents, frames, forms, tables, simple text and/or any other suitable component of a webpage or content.

Next, at step 168, the reconfiguration application analyzes and reconfigures the content of all or portions of one or more components of the source content document. The reconfiguration step may comprise any number of reconfiguration processes. Each process may be dependent upon the particular component that is to be reconfigured, such as the type and/or display size of the component, for example. In particular, the reconfiguration application may reorganize the various components such as by redistributing the various components into a logical sequence. The logical sequence facilitates in the top-down display of the source contents.

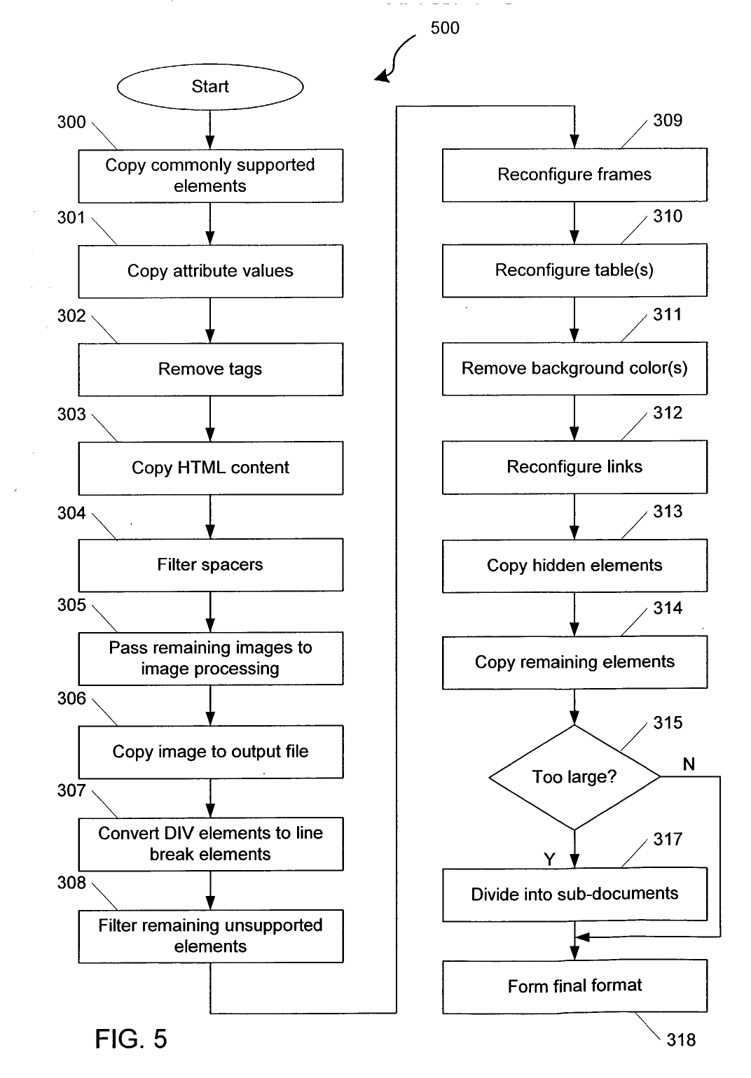

FIG. 5 shows a flowchart 500 illustrating a reconfiguration process in accordance with one embodiment of the present invention. As shown, the reconfiguration process is useful for reorganizing the output for different types of display devices based on a set of rules and user-configurable options, and according to the differing display sizes and formats. Hence, in some embodiments, the resultant output file comprises content readable by a wide variety of different devices using different formats.

At block 300, a reconfiguration application 102 (FIG. 1) copies commonly-supported elements from the source content and prepares these elements for an output stream or file. In general, a set of document elements is supportable by all, or at least many, document formats. For example, most document formats support image elements, anchor elements, and the like. In one embodiment, the source content comprises content of a web page requested from an Internet web server. These commonly supported elements may include, for example, anchor, bold, break italics, and form. Other document elements may also be commonly supported. In one embodiment, the reconfiguration application 102 includes a predetermined set of commonly-supported elements and copies elements found in the predetermined set of commonly supported elements.

Next, at block 301, the reconfiguration application 102 copies element attributes, including attributes of document components not normally visible but contained in the underlying document structure, from the source content and prepares these element attributes for the output stream. In HTML, an attribute is a characteristic of a page element, such as a font. An HTML user can set font attributes, such as size and color, to different values. The copied element attributes may comprise, for example, text, values, or both for the various document elements.

At block 302, the reconfiguration application removes elements, such as tags, that are commonly not suitable for display on a variety of devices, such as those with small form factor display screens. For example, these elements may include, but are not limited to: table, tbody, td, thead, tr, map, area, script, nolayer, iframe, span, nobr, and the like. In one embodiment, the reconfiguration application 102 maintains an identification of a predetermined set of elements not commonly suitable for display on some devices. The specific elements found in the predetermined set of elements may vary. The reconfiguration application 102 then removes or filters these elements from the source content.

At block 303, the reconfiguration application 102 copies the remaining HTML content from the source and prepares the remaining HTML content for the output stream. Any title element is repositioned into the HTML head element, along with an identifier, such as the name of the reconfiguration application 102, so a user device may distinguish the present reconfiguration application 102 from others.

At block 304, the reconfiguration application 102 identifies and copies any image content, including advertisements, banners or the like, that may be present and filters any images that are identified by the reconfiguration application 102 as spacers. Spacers may be identified as images less than about 25 pixels wide, comprising a single color such as all white or all black, and images whose ALT attributes are blank or empty.

At block 305, the reconfiguration application 102 then routes the remaining image content to an image processing system, which prepares the image for later conversion into the appropriate format, type, and size suitable for display on a given device, such as a small-screen device. At block 306, the resulting image from block 305 is copied into the output file and any height and width attributes associated therewith are removed from the image to prepare the image for final processing. In addition, a line break, such as a BR tag, is inserted after each image.

At block 307, the reconfiguration application 102 converts any HTML DIV elements into line break (BR) elements. A DIV is an HTML tag element used to separate blocks of content. Some devices may be able to accommodate use of DIV elements. However, to provide for devices that may not easily accommodate use of DIV elements, at block 307, each DIV element is replaced with a line break element, which may be more easily accommodated by a wide range of devices.

Next, at block 308, the reconfiguration application 102 filters remaining unsupported elements, or tags. These elements may include, for example, STYLE, LAYER, and the like. Again, since some devices may not support such elements, these elements are removed or filtered. It should be noted, however, that content within these elements is not filtered at this step.

At block 309, the reconfiguration application 102 reconfigures any frames into a list of links, one link for each frame, that the user may then later navigate to individually. A frame is an individual, separate HTML file or document. For example, if there are a set of four frames, the reconfiguration application will generate a corresponding set of four links. These links are then listed in the output file. An end user at the client device 110 may then receive content associated with one of the frames by activating the associated link created by the reconfiguration application 102.

At block 310, the reconfiguration application 102 removes table cells, copies the content within the removed table cells into the output file, and adds a line break (BR) element between each. Frequently, tables found in web pages may be large, having over ten (10) columns and tens of rows. Hence, because some devices may have limited, or no, ability to scroll horizontally, it may be difficult to view a table having a large number of columns with such a device. Accordingly, the reconfiguration application 102, for each column separates each row element with a line break element and then lists the row elements sequentially so as to convert a table into a single column of text with a line break after each element. Pursuant to one embodiment, the function of block 310 is performed by replacing each TD tag with a line break (BR) tag. As those skilled in the art will appreciate, a TD tag is generally used to mark up individual cells in a table row.

At block 311, the reconfiguration application 102 removes any background colors. Many device types or formats do not support a background color. Accordingly, by removing the background color, the content may be more easily accommodated by a wider range of devices.

At block 312, the reconfiguration application 102 copies all anchors or links, filters any script or objects within the links, and copies the remaining attributes, like HREF, and any label text or image into the output stream. Many devices do not support scripts, objects, or the like. Accordingly, any scripts or objects are removed from the content and are replaced with an appropriate text message regarding same. Further, at block 312, HREF (Hyperlink Reference) attributes, which comprise hidden values, are copied to the output file by the reconfiguration application.

At block 313, the reconfiguration application 102 copies all “hidden” elements or text from input fields and copies them into the output stream. Some document elements have a hidden attribute inside of an input element. These hidden elements are commonly used in documents including one or more forms. The hidden text elements may comprise elements having an input type equal “hidden.” When a form is copied, there are typically one or more elements having “input type=hidden.” Hence, at block 313, the reconfiguration application 102 copies these elements having input type=hidden.

At block 314, the reconfiguration application 102 copies all remaining elements or text into the output file. A discussed above, much of the content has been filtered or copied to the output stream. At block 314, the reconfiguration application copies any remaining content that has not been filtered to the output stream. This remaining content, or elements, may include form inputs and text.

At block 315, the reconfiguration application 102 determines whether the size of the output file exceeds a certain predetermined threshold. In one embodiment, the predetermined threshold is based, at least in part, on the size of the memory of the requesting device. Hence, a requesting device having a large memory may be capable of receiving a greater amount of content than a requesting device having a smaller memory.

If the size of the remaining content is larger than the predetermined threshold, execution proceeds to block 317, else execution proceeds to block 318. At block 317, the reconfiguration application divides the reconfiguration output file into smaller sections, or sub-documents, and links the smaller sub-documents by including a link in one sub-document that links that sub-document to a subsequent sub-document, if any. Long URLs are converted into a symbol representing the true URL to save memory space. In one embodiment, this symbol comprises a two-byte symbol that corresponds to the true URL in a table stored at the reconfiguration application 102.

At block 318, the reconfiguration application 102 determines the display size and format of the requesting device and reconfigures the output stream in accordance with the display size and the format of the requesting device.

Accordingly, the resultant output file comprises content that may be received, processed, and displayed by any of a variety of devices, including some devices having small form factor displays.

In the reconfiguration process, the reconfiguration application may encounter various links to other URLs. Such links may be represented in the original HTML page as an absolute URL or a relative URL. In the case of relative URLs, it may be necessary or desirable for the reconfiguration application to convert some or all the relative URLs to absolute URLs. The reason for such conversion is that when the reconfiguration process or application reconfigures the web page, the original web page may be divided into more than one page for display such that the original web page URL may be different. Thus, the relative URL may lose meaning after the reconfiguration process and/or it may be more difficult to keep track of the original URL throughout the reconfiguration process. By converting all relative URLs encountered in the source document to absolute URLs, the end user may select or click on the link and be directed to contents at the desired URL. For example, the source for an HTML page residing at www.any_company.com/list/a.html may include a relative URL “/b.html” that is equivalent to the absolute URL www.any.com/b.html. As another example, the source for an HTML page residing at www.any.com/list/a.html may include a relative URL “c.html” that is equivalent to the absolute URL www.any.com/list/c.html.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

What is claimed is:

1. A method for reconfiguring source content for display on a client display, the method comprising:
receiving a source content from a source;
filtering a set of predetermined elements that are not commonly supported by devices having small displays;
identifying a table within the source content, the table having a plurality of table cells arranged in columns and rows;
copying content from individual table cells; and
separating the content from individual table cells by a line break element.

2. The method according to claim 1, further comprising filtering images having less than a predetermined width, a single color, and an empty ALT attribute.

3. The method according to claim 1, further comprising:
removing height and width attributes of an image within the source content;
copying the resultant image into an output file;
determining a type of device requesting the source content;
resizing the image based on the type of the device requesting the source content.

4. The method according to claim 1, further comprising:
identifying a plurality of frames within the source content;
creating a link associated with each of the frames;
listing the link in an output file.

5. The method according to claim 1, wherein the source content includes a background color, further comprising removing the background color.

6. The method according to claim 1, wherein the source content comprises scripts, further comprising removing the scripts.

7. The method according to claim 1, wherein the source content comprises HREF attributes, further comprising copying the HREF attributes to an output file.

8. The method according to claim 1, wherein the source content comprises an HTML document including at least one DIV element, further comprising replacing each DIV element with a line break element.

9. The method according to claim 1, wherein the source content comprises at least one Uniform Resource Locator (URL), further comprising:
creating a symbol representing the URL;
saving the symbol in an output file;
associating the symbol with the URL in a lookup table.

10. The method according to claim 1, further comprising:
copying non-filtered portions of the source content to an output file;
determining whether the source content exceeds a threshold size;
if the source content exceeds the threshold size, dividing the source content into a plurality of sub-documents, each sub-document having a size smaller or equal to the threshold size;
at least one of the sub-documents including a link to at least one other of the sub-documents.

11. The method according to claim 10, wherein the threshold size varies depending on a type of device requesting the source content.

12. A method for reconfiguring source content for display on a client display, the method comprising:
receiving a source content from a source;
filtering a set of predetermined elements that are not commonly supported by devices having small displays;
filtering images having less than a predetermined width, a single color, and an empty ALT attribute;
storing the filtered source content as an output file.

13. The method according to claim 12, further comprising:
removing height and width attributes of an image within the source content;
copying the resultant image into an output file;
determining a type of device requesting the source content;
resizing and re-formatting the image based on the type of the device requesting the source content.

14. The method according to claim 12, further comprising:
identifying a table within the source content, the table having a plurality of table cells arranged in columns and rows;
copying content from individual table cells; and
separating the content from individual table cells by a line break element.

15. The method according to claim 12, wherein the source content comprises at least one Uniform Resource Locator (URL), further comprising:
creating a symbol representing the URL;
saving the symbol in an output file;
associating the symbol with the URL in a lookup table.

16. The method according to claim 12, wherein the source content comprises an HTML document including at least one DUV element, further comprising replacing each DIV element with a line break element.

17. The method according to claim 12, further comprising:
identifying a plurality of frames within the source content;
creating a link associated with each of the frames;
listing the link in an output file.

18. The method according to claim 12, further comprising:
copying non-filtered portions of the source content to the output file;
determining whether the source content exceeds a threshold size;
if the source content exceeds the threshold size, dividing the source content into a plurality of sub-documents, each sub-document having a size smaller or equal to the threshold size;
at least one of the sub-documents including a link to at least one other of the sub-documents.

19. The method according to claim 18, wherein the threshold size varies depending on a type of device requesting the source content.

20. A method for reconfiguring source content for display on a client display, 4 the method comprising:
filtering from the source content a set of predetermined elements that are not commonly supported by devices having small displays;
identifying a table within the source content, the table having a plurality of table cells arranged in columns and rows;
copying table content from individual table cells; and
separating the table content from individual table cells by a line break element;
filtering images from the source content having less than a predetermined width, a single color, and an empty ALT attribute;
removing height and width attributes of an image within the source content;
determining a type of device requesting the source content;
resizing the image based on the type of the device requesting the source content;
identifying a plurality of frames within the source content;
creating a link associated with each of the frames and listing the link in the output file;
removing a background color from the source content;
removing at least one script from the source content
determining whether the source content exceeds a threshold size;
if the source content exceeds the threshold size, dividing the source content into a plurality of sub-documents, each sub-document having a size smaller or equal to the threshold size;
at least one of the sub-documents including a link to at least one other of the sub-documents, wherein the threshold size varies depending on a type of device requesting the source content.
